(19) United States
(12) Patent Application Publication
(10) Pub. No.: US 2023/0316422 A1
(43) Pub. Date: Oct. 5, 2023

(54) REWARD ENGINES

(71) Applicant: Zinkt Inc., Toronto (CA)

(72) Inventors: Michael Zaranyik, Brantford (CA); Thomas Francis Edward Swinbourne, Birmingham (GB); Matthew James Williams, Oakville (CA)

(73) Assignee: Zinkt Inc., Toronto, ON (CA)

(21) Appl. No.: 18/193,185

(22) Filed: Mar. 30, 2023

Related U.S. Application Data
(60) Provisional application No. 63/362,131, filed on Mar. 30, 2022.

(51) Int. Cl. G06Q 40/12; G06Q 10/0639

(52) U.S. Cl. CPC G06Q 40/125; G06Q 10/06398

(57) ABSTRACT

An example of an apparatus and a method to provide a one-time bonus is provided. The apparatus includes a database management system to maintain a plurality of records. In addition, the apparatus includes a determination engine in communication with the database management system. The determination engine is to identify at least one rewardable record in the plurality of records. Furthermore, the apparatus includes an aggregator to determine if the at least one rewardable record meets a predetermined threshold. The apparatus also includes a communications interface to transmit a command to an external resource. The external resource is to execute the command to provide a payment to a sales agent associated with the at least one rewardable record.

### CROSS REFERENCE TO RELATED APPLICATIONS

This application claims priority to U.S. Provisional Application No. 63/362,131, filed Mar. 30, 2022, which is herein incorporated by reference in its entirety.

### BACKGROUND

Businesses operate by interacting with clients of customers. Information about clients and customers, including former, present and prospective clients and customers, may be collected, stored and managed by a customer relationship management system. It is known that a customer relationship management system may collect and compile a vast amount of data associated with each client or customer including current information available online, communications with the client or customer. For example, data relating to the amount of client interaction as well as the client's preferences for communication may be stored. The data may be collected via various methods such as surveys or data collected from interactions with the client or customer. Accordingly, the customer relationship management system may maintain data for each client or customer of the business including past sales data, marketing efforts, contacts with various parties such as employees and contractors, sales agents. managers, partners, and customers.

In addition, a business may employ different people who receive compensation that may vary based on their employment agreements. The varying compensation may be based on various performance metrics, such as sales and/or revenue data for a sales agent or number of tickets resolved for IT support personnel. One way to compensate people is to provide a one-time reward upon satisfying a set of conditions.

### SUMMARY

In accordance with an aspect of the invention, there is provided an apparatus. The apparatus includes a database management system to maintain a plurality of records. In addition, the apparatus includes a determination engine in communication with the database management system. The determination engine is to identify at least one rewardable record in the plurality of records. Furthermore, the apparatus includes an aggregator to determine if the at least one rewardable record meets a predetermined threshold. The apparatus also includes a communications interface to transmit a command to an external resource to issue a reward. The external resource is to execute the command to provide a reward to a sales agent associated with the at least one rewardable record.

The database management system may be a customer relationship management system. The apparatus may further include a reward database to store a copy of the at least one rewardable record associated with the sales agent. The reward database may track when the reward is provided to the sales agent. The communications interface may receive a request for the at least one rewardable record from a device associated with the sales agent. The apparatus may further include a verification engine to verify the request. The apparatus may further include a reward selector to select an appropriate reward for the attained target based on a predetermined threshold. The determination engine may periodically iterate until the aggregator determined the at least one rewardable record meets the predetermined threshold.

In accordance with another aspect of the invention, there is provided a method. The method involves identifying at least one rewardable record in the plurality of records stored in a database management system. In addition, the method involves determining if the at least one rewardable record meets a predetermined threshold. Furthermore, the method involves transmitting a command to an external resource to issue a reward. The external service is to execute the command to provide a reward to a sales agent associated with the at least one rewardable record.

In accordance with another aspect of the invention, there is provided a non-transitory machine-readable storage medium encoded with instructions executable by a processor. The non-transitory machine-readable storage medium includes instructions to identify at least one rewardable record in the plurality of records stored in a database management system. In addition, the non-transitory machine-readable storage medium includes instructions to determine if the at least one rewardable record meets a predetermined threshold. Furthermore, the non-transitory machine-readable storage medium includes instructions to transmit a command to an external resource. The external service is to execute the command to provide a reward to a sales agent associated with the at least one rewardable record.

### BRIEF DESCRIPTION OF THE DRAWINGS

Reference will now be made, by way of example only, to the accompanying drawings in which:

FIG. 1 is a block diagram of an example apparatus to generate a command to issue a reward;

FIG. 2 is a block diagram of another example apparatus to generate a command to issue a reward;

FIG. 3 is a diagram of an example system to determine a reward and to provide a reward; and

FIG. 4 is a flowchart of an example method of generating a command to issue a reward.

### DETAILED DESCRIPTION

Database management systems are used by businesses and organizations to collect, store, and extract useful information. The data stored in a database management system is not particularly limited and may include data associate with various aspects of the business. In one example, the data may include customer relationship data to track various metrics associated with a customer with whom the business or organization has a connection. The connection may be a relationship where the business is carried out with the customer on a regular or periodic basis. Another relationship type may that there was a former business relationship or the relationship may be one where the customer is a prospective customer. The data collected may include a wide variety of data, such as sales data, marketing efforts, contacts with employees and contractors, such as sales agents and other data for existing and former customers. Such data may be used to increase sales and/or target advertising to existing and former customers. In particular, the data may provide information that can be used to evaluate the success of various marketing efforts and campaigns. For prospective customers, the data may be collected from publicly available sources as well as through targeted surveys and used to design marketing campaigns to convert the prospective customer to an existing customer.

In many examples, the data associated with each customer includes data about the interactions with the customer. In some instances, the interactions are automated, such as sending periodic advertisements to a customer list via mail, email, or other forms of communication. In other instances, the interactions may include interactions between a sales agent and customer such as a phone call, email communication, or in-person meeting. The data may include the details of each interaction and track the sales agent involved with the interaction. Furthermore, each contract or sale may be linked with a specific sales agent to provide data that may be used to evaluate the performance of the sales agent or to provide incentives for a sales agent that meets or exceeds a target.

It is to be appreciated by a person skilled in the art with the benefit of this description that the database management system may be configured to organize data in a specific manner to provide information. In the above example where the database management system is a customer relationship management system, the data is organized to store data in data records associated with a customer. This provides for easy retrieval of information associated with the customer or group of related customers to be used to develop marketing campaigns and business development strategies that may be predicted to be effective for the customer or group of customers. In addition to improving interactions with customers, the business or organization typically compensates some employees and contractors, such as sales agents based on performance. In particular, various metrics may be used to evaluate the performance of a sales agent.

An apparatus and associated method to process data records to determine when a reward is to be provided to a sales agent is provided. In the present example, the data records are store in a database management system, such as a customer relationship management system. The relevant data records are processed to generate standardized data which may be transmitted along with a command to an external service for additional processing. In particular, the targeted data records may be records associated with an employee or contractor, such as a sales agent, such as records associated with a customer with whom the sales agent has had an interaction. The data records are analyzed automatically to determine if a sales agent has met a predetermined target for an incentive. Upon determining and/or confirming that the target is met, a command is issued to provide a reward to the sales agent. The command is not particularly limited, but may be a command to an external resource that specializes in reward and incentive programs.

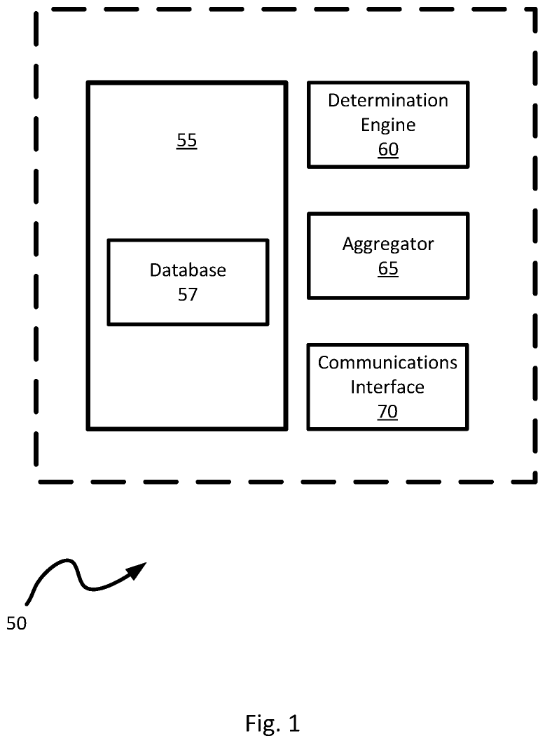

Referring to FIG. 1, an example of an apparatus to provide a one-time bonus is generally shown at 50. In particular, the apparatus 50 is to generate a command to issue a reward based on data aggregated from multiple sources. The apparatus 50 may include additional components, such as various memory storage units, additional interfaces to communicate with other devices, and further input and output devices to interact with a user or an administrator of the apparatus 50. In addition, the apparatus 50 may be separated into multiple components operating as a system as described in greater detail below. In some examples, the components may be distributed across multiple locations and operate as a cloud service. In the present example, the apparatus 50 includes a database management system 55, a determination engine 60, an aggregator 65, and communications interface 70.

The database management system 55 is to maintain various databases, each database having a plurality of data records. The databases are not particularly limited and may include a wide variety of different types of data records. In the present example, the database management system 55 is a customer relationship management system, such as SAP, ORACLE, or SALESFORCE.

In the present example, it may. be assumed that the employee or contractor is a sales agent representing the company and that the database 57 is maintained within the database management system 55. Continuing with the present example where the database management system 55 is a customer relationship management system, the database 57 may store a plurality data records where each data record is associated with a customer. Some of the data records associated with existing customers include information about interactions with the customer. For example, the data records may include the identification of a sales agent associated with the customer. In some examples, a customer may be associated with more than one sales agent. The data record may also include raw sales data, opportunity data, or other financial information including expenses and other costs associated with the customer. For customers with more than one associated sales agent, the financial information, such as revenue and costs, may be divided amount the sales agents. It is to be appreciated by a person of skill in the art with the benefit of this description that the manner by which the financials are divided among sales agents are not particularly limited and may be predetermined by the administrator of the apparatus.

In some examples, the database 57 may not be accessible to the sales agents. In particular, the data records stored in the database 57 may include confidential and proprietary information that may be accessible by an administrator or other user with appropriate credentials.

A determination engine 60 is to be in communication with the database management system 55. In the present example, the determination engine 60 is to analyze the data records stored in the database 57 to identify a rewardable record or multiple rewardable records. The manner by which the determination engine 60 identifies a rewardable record from the data records stored in the database 57 is not particularly limited. For example, the determination engine 60 may have a predetermined set of criteria or thresholds to define events that are deemed to be rewardable. For example, a client meeting may be considered to be a rewardable event and thus any data record indicating a client meeting with a sales agent may be considered a rewardable record. In other examples, rewardable events may include a scheduled phone call with a client, a closed sale, meetings booked, products sold, sales targets reached, customer contract renewals, customer satisfaction scores achieved, rewards collected, etc.

As the database 57 may be continuously updated during the normal course of business, it is to be appreciated by a person of skill in the art with the benefit of this description that the determination engine 60 may continuously analyze the data records in an iterative manner to identify any data records as rewardable records that were not previously identified. As an example, if the criteria for being considered a rewardable record if arranging a client meeting, it is to be appreciate that new client meetings may be scheduled to convert the data record to a rewardable record.

In the present example, the determination engine 60 may generate a list of rewardable records and the sales agent associated with each rewardable record. Accordingly, the list may point to the actual data record in the database 57 such that the aggregator 65 may analyze the data record within the database 57 without having to generate additional copies in a separate location. However, in other examples, a separate reward database may be used to store a copy of the rewardable records associated with each sales agent. In these examples, the rewardable records may be modified in the reward database to improve functionality. For example, information not relevant to the determination of a reward for the sales agent may be stripped to save space. Furthermore, additional information, such as tracking of any rewards that may have been provided to the sales agent may be stored in the modified rewardable record stored on the reward database. It is also to be appreciated by a person of skill with the benefit of this description that by using a separate reward database that is not connected to the database 57 may provide additional features, such as access for the sales agent, without compromising the data integrity of the database 57.

The aggregator 65 is to determine if the rewardable record or plurality of rewardable records meet a predetermined threshold. In the present example, the aggregator 65 retrieves the rewardable records associated with a sales agent from the database 57 or a separate reward database in examples that include the reward database. Once the rewardable records associated with a sales agent are analyzed by the aggregator 65, a determination is made as to whether the predetermined threshold has been met. Continuing with the example above where the rewardable event is the arrangement of a client meeting, the predetermined threshold may be a sales agent arranging ten client meetings. In this example, the aggregator 65 may analyze each rewardable record to add the number of valid client meetings to determine if there are ten valid client meetings. If the predetermined threshold is not met, no further action is taken. In the present example, the determination engine 60 will continue to operate to identify additional rewardable records or update rewardable records if multiple client meetings are arranged and recorded in the same data record. This process may iterate until the predetermined threshold is met. In some examples, once the predetermined threshold is met a specific reward may be determined. For example, the apparatus 50 may further include a payment calculator to calculate a payment amount in examples where the reward or payment is a monetary amount. In other examples, rewards may be selected from a group determined by the aggregator 65.

The communications interface 70 is to communicate with an external resource. In particular, the communications interface 70 is to transmit a command to the external resource to issue a reward or payment. In the present example, the external resource is to execute the command and to provide a reward to the sales agent associated with the rewardable records aggregated by the aggregator 65. The reward may be a one-time reward with a value associated with the predetermined threshold, which may be considered a sales target. The manner by which the reward is selected is not particularly limited. For example, the reward may be calculated or selected at the external resource based on a known schedule to provide the reward in a near real-time manner. In other examples, a reward selector may be part of the apparatus 50 and used to calculate the value for the reward based on a predetermined set of rules. Furthermore, the reward is also not particularly limited and may vary depending on the external resource used to issue the reward or payment. In particular, while the reward or payment may be gift cards with a known value, some examples may use other forms of rewards, such as vouchers, cryptocurrency, coupons, an amount of currency, physical gifts, etc. Upon issuing the reward, the rewardable records may be updated to reflect that a reward has been issued and to restart the count toward the predetermined threshold.

It is to be appreciated that the communications interface 70 may also connect with additional devices such as user devices of the sales agents or supervisors. For example, the communications interface 70 may receive a request from a sales agent for the rewardable records associate with the sales agent. This may be used by the sales agent for verification purposes or planning purposes. Similarly, a supervisor may request rewardable records from multiple sales agents to monitor performance. In these examples, it is to be appreciated that an additional verification engine may be used to verify each request to ensure authenticity. The manner by which the verification engine carries out this task is not limited and may involve a username and password along with additional security measures. The verification may be carried out automatically, such as through a verification process carried out by within the verification engine. In other examples, the verification may be carried out by the sales agent manually by comparing the data to their own records. In further examples, a manager or other superior of the sales agent may be asked to verify, approve, and/or adjust the reward prior to sending the command to the external resource.

Various advantages will now be apparent to a person of skill in the art with the benefit of the present description. In particular, the apparatus provides a way to efficiently analyze the data in the database 57 in an autonomous manner to accurately provide rewards to sales agents.

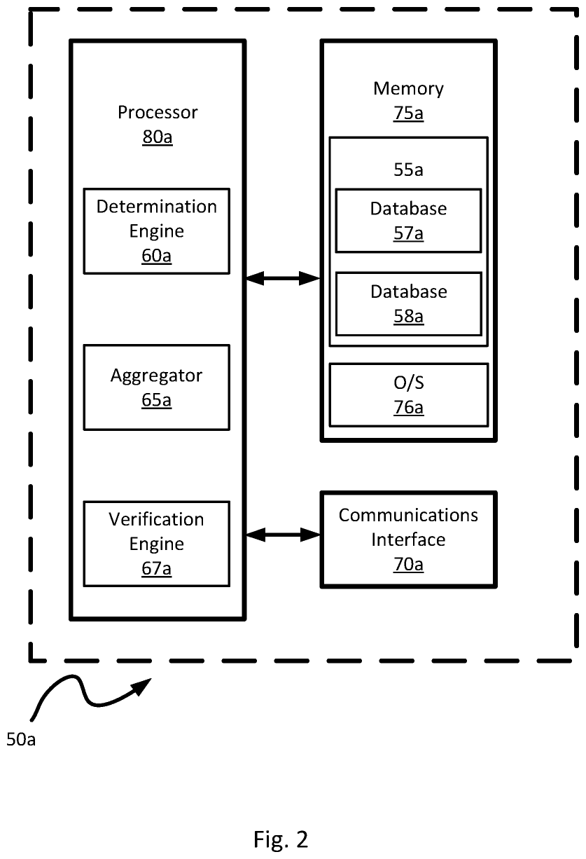

Referring to FIG. 2, another example an apparatus 50a to generate a command to issue a reward based on data aggregated from multiple sources is generally shown. Like components of the apparatus 50a bear like reference to their counterparts in the apparatus 50, except followed by the suffix “a”. The apparatus 50a includes a communications interface 70a, a memory storage unit 75a, and a processor 80a. In the present example, a determination engine 60a, an aggregator 65a, and a verification engine 67a are implemented by the processor 80a. Furthermore, the database management system 55a is maintained in the memory storage unit 75a.

In the present example, the memory storage unit 75a is to store various data and information on the apparatus 50a. The memory storage unit 75a is not particularly limited and may include various types of computer memory devices. For example, the memory storage unit 75a may include a non-transitory machine-readable storage medium that may be, for example, an electronic, magnetic, optical, or other physical storage device. In the present example, the database management system 55a is maintained in the memory storage unit 75a. In addition, the memory storage unit 75a may store an operating system 76a that is executable by the processor 80a to provide general functionality to the apparatus 50a. The operating system 76a is not particularly limited and may include WINDOWS, MACOS, IOS, ANDROID, LINUX, and UNIX. In addition, the memory storage unit 75a may additionally store instructions to operate peripheral devices at the driver level of the apparatus 50a, such as to operate the communications interface 70a and the processor 80a.

The database management system 55a is not particularly limited and functions similar to the database management system 55 described above. In particular, the database management system 55a includes the database 57a, which may store customer data records in a customer relationship management system, such as SAP, ORACLE, or SALESFORCE. The database management system 55a also includes the database 58a, which may store copies of data records associated with reward for which a sales agent is eligible. Accordingly, the database 58a may be used to collect rewardable records associated with a sales agent such that the aggregator 65a can quickly identify when the predetermined threshold is met for the sales agent. It is to be appreciated by a person of skill with the benefit of this description that by providing a smaller database 58a to scan, the aggregator 65a may determine whether the predetermined threshold is met more efficiently than if the aggregator 65a was to scan the database 57a which include both rewardable records and non-rewardable records.

The processor 80a may include a central processing unit (CPU), a graphics processing unit (GPU), a microcontroller, a microprocessor, a processing core, a field-programmable gate array (FPGA), an application-specific integrated circuit (ASIC), or similar. The processor 80a and the memory storage unit 75a may cooperate to execute various instructions, such as for the processor 80a to carry out operations in the database management system 55a or for the processor 80a to be directed by instructions store in the memory storage unit 75a. In particular, the processor 80a may execute instructions stored on the memory storage unit 75a to implement the determination engine 60a, the aggregator 65a, and the verification engine 67a.

Although the present example shows the processor 80a implementing the determination engine 60a, the aggregator 65a, and the verification engine 67a, it is to be appreciated by a person of skill with the benefit of this description that variations are contemplated. For example, the determination engine 60a, the aggregator 65a, and the verification engine 67a may be implemented on multiple processors. In this example, each of the determination engine 60a, the aggregator 65a, and the verification engine 67a may be operated on a separate processor within the apparatus 50a. In further examples, determination engine 60a, the aggregator 65a, and the verification engine 67a may be operated on a separate machine, such as from a software as a service provider or in a virtual cloud server.

The determination engine 60a and the aggregator 65a are not particularly limited and function similar to the determination engine 60 and the aggregator 65 described above, respectively.

In the present example, the apparatus 50a further includes a verification engine 67a implemented by the processor 80a. The verification engine 67a is not particularly limited and provides the ability to verify the identity of a sales agent. In the present example, the database 58a may be accessible to a sales agent with the proper credentials. Accordingly, if the sales agent request access to a rewardable record in the database 58a, the request may be processed to by the verification engine 67a to confirm the identity of the sales agent. In another example, the verification engine 67a may be used to verify the identity of the sales agent entering data into a data record on the database 57a, such as to log an event with which the sales agent was involved. The manner by which the request is verified is not particularly limited. For example, the verification engine 67a may prompt a requester for a username and password upon receiving a request for a standardized data record. In other examples, the request may include verification data collected by the device of the sales agent. The verification data may include biometric data. Further examples, may include a verification engine 67a using multi-factor verification processes, such as a token system.

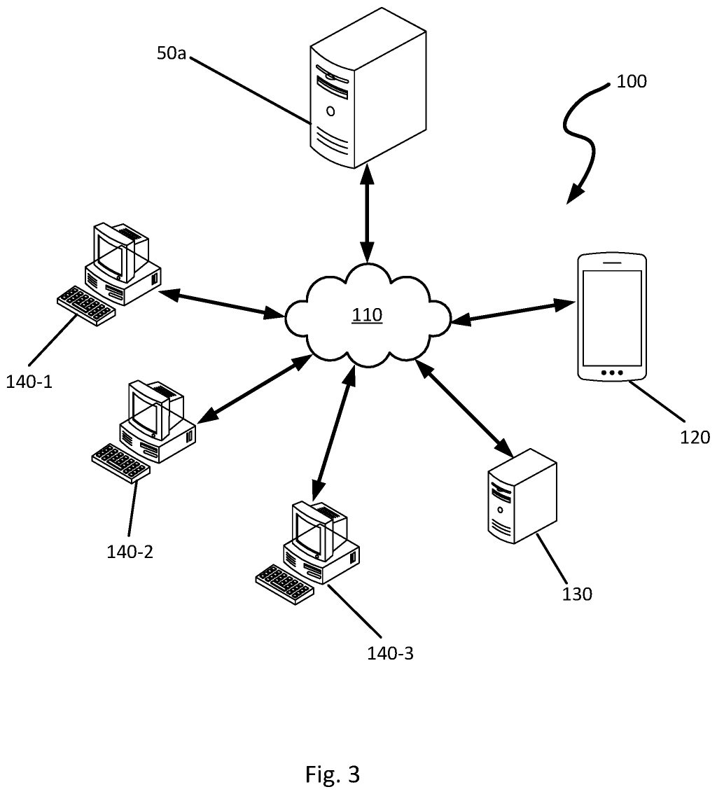

Referring to FIG. 3, an example of a system 100 to provide a one-time bonus to a sales agent is generally shown. In the present example, the apparatus 50a is in communication with a sales agent device 120, an external service 130, and external data sources 140-1, 140-2, 140-3 (generically, these external data sources are referred to herein as “external data source 140” and collectively they are referred to as “external data sources 140”) via a network 110. It is to be appreciated that the sales agent device 120, the external service 130, and the external data sources 140 are not limited and variations capable of performing the design functions may be substituted. Furthermore, although the present example illustrates a single sales agent device 120 and a single external service 130, additional devices may be added to the system 100. In particular, a business or organization operating the system 100 may have multiple sales agents each with a separate sales agent device 120.

The sales agent device 120 may be any type of electronic device used by a sales agent to access a data record, such as data records stored in the database 57a or the database 58a. Some examples of devices that may be used as a sales agent device 120 are a smartphone, a tablet, a laptop, a desktop computer, or any other device capable of receiving user input to and generating user output. The sales agent device 120 includes its own communications interface, and processor. The sales agent device 120 may also include input, such as a keyboard, pointer, and or touchscreen, and/or output devices such as a display or touchscreen display. For example, the sales agent device 120 may be preloaded with an application to provide a convenient user interface from which the sales agent can request information to be provided in a user friendly format such that the sales agent may monitor their own performance.

The external service 130 is to receive the command from the apparatus 50a. In the present example, the external service 130 is a system configured to issue a reward or payment. Accordingly, the external service 130 is to execute the command and to provide a reward to the sales agent associated with the rewardable records aggregated by the aggregator 65a. The external service 130 is not particularly limited and dependent on the type of reward or payment to be issued to the sales agent. For example, the external service 130 may be a gift card provider to generate gift cards with a known value. In other examples, the external service 130 may be a financial service provider to issue vouchers, cryptocurrency, coupons, etc. IN the present example, a single external service 130 is show; however, it is to be appreciated by a person of skill with the benefit of this description that additional external services 130 may be added to the system to provide choice to the sales agent over the particular reward provided to use.

In the present example, the external data source 140 is a source of data to populate the data records in the database 57a. The external data source 140 is not particularly limited and may be any type of data entry device such as a smartphone, a tablet, a laptop, a desktop computer, or any other device capable of receiving user input. Accordingly, each external data source 140 may be to provide data to populate information about each customer associated with a data record in the database 57a. The data may include meetings with sales associates or other events that may be rewardable. For example, each external data source 140 may be a terminal used by an administrator or assistant organizing events and entering data. In some examples, an external data source 140 may be the same physical device as the sales agent device 120 when the sales agent enters data to populate the data records in the database 57a.

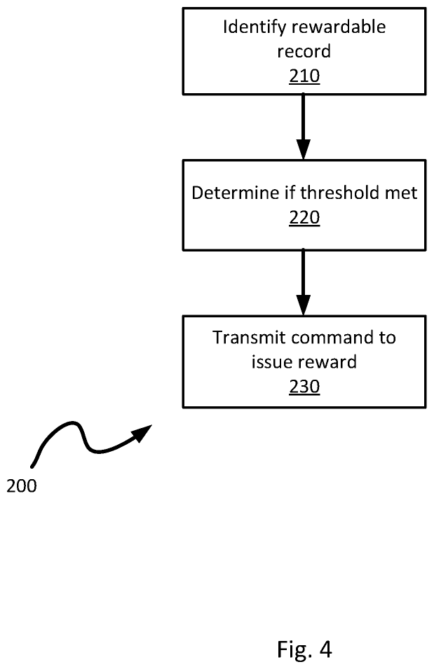

Referring to FIG. 4, a flowchart of an example method of providing a one-time bonus is generally shown at 200. In order to assist in the explanation of method 200, it will be assumed that method 200 may be performed by the apparatus 50. Indeed, the method 200 may be one way in which the apparatus 50 may be configured. It is to be emphasized, that method 200 may not be performed in the exact sequence as shown, and various blocks may be performed in parallel rather than in sequence, or in a different sequence altogether.

Beginning at block 210, a rewardable record from the database 57a is identified based on a predetermined set of criteria. In the present example, the criteria not particularly limited and may be set by the business or organization for which a sales agent is employed. The data record in the database 57a may include data such as metrics associated with the rewardable event.

Block 220 comprises determining if the rewardable record or plurality of rewardable records identified at block 210 meet a predetermined threshold. In the event that the predetermined threshold is met, a command is sent to an external resource (at block 230). The external resource is to execute the command and provide a reward to the sales agent associated with the rewardable records identified at block 210.

It should be recognized that features and aspects of the various examples provided above may be combined into further examples that also fall within the scope of the present disclosure.

What is claimed is:

1. An apparatus comprising:
a database management system to maintain a plurality of records;
a determination engine in communication with the database management system, wherein the determination engine is to identify at least one rewardable record in the plurality of records;
an aggregator to determine if the at least one rewardable record meets a predetermined threshold; and
a communications interface to transmit a command to an external resource, wherein the external resource is to execute the command to provide a payment to a sales agent associated with the at least one rewardable record.

2. The apparatus of claim 1, wherein the database management system is a customer relationship management system.

3. The apparatus of claim 2, further comprising a reward database to store a copy of the at least one rewardable record associated with the sales agent.

4. The apparatus of claim 3, wherein the reward database tracks when the payment is provided to the sales agent.

5. The apparatus of claim 1, wherein the communications interface is to receive a request for the at least one rewardable record from a device associated with the sales agent.

6. The apparatus of claim 5, further comprising a verification engine to verify the request.

7. The apparatus of claim 6, further comprising a payment calculator to calculate an amount for the payment.

8. The apparatus of claim 1, wherein the determination engine periodically iterates until the aggregator determined the at least one rewardable record meets the predetermined threshold.

9. A method comprising:
identifying at least one rewardable record in a plurality of records stored in a database management system;
determining if the at least one rewardable record meets a predetermined threshold; and
transmitting a command to an external service, wherein the external service is to execute the command to provide a payment to a sales agent associated with the at least one rewardable record.

10. The method of claim 9, wherein the plurality of records is stored in a customer relationship management system.

11. The method of claim 10, further comprising storing a copy of the at least one rewardable record associated with the sales agent in a reward database.

12. The method of claim 11, further comprising tracking the payment provided to the sales agent.

13. The method of claim 9, further comprising receiving a request for the at least one rewardable record from a device associated with the sales agent.

14. The method of claim 13, further comprising verifying the request.

15. The method of claim 14, further comprising calculating an amount for the payment.

16. The method of claim 9, wherein determining if the at least one rewardable record meets the predetermined threshold comprises repeating a determination step until at least one rewardable record meets the predetermined threshold.

17. A non-transitory machine-readable storage medium encoded with instructions executable by a processor, the non-transitory machine-readable storage medium comprising:
instructions to identify at least one rewardable record in a plurality of records stored in a database management system;
instructions to determine if the at least one rewardable record meets a predetermined threshold; and
instructions to transmit a command to an external resource, wherein an external service is to execute the command to provide a payment to a sales agent associated with the at least one rewardable record.

18. The non-transitory machine-readable storage medium of claim 17, wherein the non-transitory machine-readable storage medium comprises instructions to store a copy of the at least one rewardable record associated with the sales agent in a reward database.

19. The non-transitory machine-readable storage medium of claim 17, wherein the non-transitory machine-readable storage medium comprises instructions to receive a request for the at least one rewardable record from a device associated with the sales agent.

20. The non-transitory machine-readable storage medium of claim 17, wherein the non-transitory machine-readable storage medium comprises instructions to repeat a determination step until at least one rewardable record meets the predetermined threshold.
